(19) United States
(12) Patent Application Publication
(10) Pub. No.: US 2022/0322725 A1
(43) Pub. Date: Oct. 13, 2022

(54) ANTICAKING ADDITIVES AND METHODS FOR IMPROVING THE FLOWABILITY OF A FOODSTUFF

(71) Applicant: Morton Salt, Inc., Chicago, IL (US)

(72) Inventors: Siddique Ali Khateeb RAZACK, Lombard, IL (US); Mohamadkheir ALKHATEEB, Naperville, IL (US); Zach GOODING, Bloomingdale, IL (US); John MacKINNON, Chicago, IL (US); Linda KRAGT, Chicago, IL (US); Elizabeth PIERONI, Crystal Lake, IL (US)

(21) Appl. No.: 17/705,023

(22) Filed: Mar. 25, 2022

Related U.S. Application Data
(60) Provisional application No. 63/166,782, filed on Mar. 26, 2021.

(51) Int. Cl. A23P 10/43; A23L 27/40; A23P 10/47

(52) U.S. Cl. CPC A23P 10/43; A23L 27/40; A23P 10/47; A23V 2002/00

(57) ABSTRACT

The present application describes methods of reducing caking in and improving the flowability of a powdered material. The methods generally involve adding a naturally-derived additive to the powdered material that is capable of reducing caking within the powdered material, while also improving the flowability of the powdered material. For example, following treatment with the naturally-derived additive, the treated powdered materials generally demonstrate reduced overall caking and crust thickness. In some of the methods described herein, the naturally-derived additive belongs to the saponin class of chemicals. In other of the methods described herein, the naturally-derived additive is potassium cocoate. The present application also describes food additive formulations that include a saponin or potassium cocoate and demonstrate reduced caking and improved flowability of a granulated foodstuff.

### CROSS REFERENCE TO RELATED APPLICATIONS

The present application claims the benefit of U.S. Provisional Patent Application No. 63/166,782, filed Mar. 26, 2021, which is hereby incorporated herein by reference in its entirety.

### TECHNICAL FIELD

The present disclosure relates to methods of reducing caking in a powdered material (e.g. a foodstuff) and improving the flowability of the powdered material. The present disclosure additionally relates to food additive formulations that include a quillaja saponin, where the food additive formulations demonstrate reduced caking and improved flowability.

### BACKGROUND

Anticaking agents are commonly used additives that are added to powdered and granulated materials to prevent the formation of lumps, which is also known as “caking”, within the powdered or granulated material. Anticaking agents are therefore useful in improving the ease of packaging, transporting, dispensing, and consuming the powdered or granulated materials. It is because of these improved physical properties that anticaking agents are ubiquitously used in a variety of industries, including foodstuff manufacturing.

Without anti-caking agents, dry goods such as soups, pre-packaged baking mixes, and staples like salt, flour, and spices would clump to a nearly unusable extent. This is because these products are generally hygroscopic, meaning that they absorb moisture from ambient air, which promotes strong bonding between particles of the foodstuff that dramatically reduces the flowability, and therefore usability, of the foodstuff.

Though virtually all anticaking agents in use today are generally recognized as safe by regulatory agencies, such as the U.S. Food and Drug Administration, consumer interests are shifting, and many individuals prefer food products with fewer synthetic additives. Thus, there is a significant need to identify and develop new anticaking agents that are “naturally derived.”

### SUMMARY

Disclosed herein are methods for reducing the caking and improving the flowability of a powdered material. The methods generally include adding an anti-caking agent to the powdered material at a concentration sufficient to reduce the average caking of the powdered material. In some embodiments, the methods generally include adding a saponin to the powdered material at a concentration sufficient to reduce the average caking of the powdered material. In some embodiments, the methods generally include adding a quillaja saponin to the powdered material at a concentration sufficient to reduce the average caking of the powdered material. For example, in some methods described herein, the anti-caking agent (e.g. quillaja saponin and/or potassium cocoate) is added to the powdered material at a concentration sufficient to reduce the average caking of the powdered material to less than about 40%. The anticaking properties of powdered materials treated with the anti-caking agent are additionally determined by assessing the average crust thickness and hardness of caking within the powdered material.

Some of the methods described herein include a step of applying a quillaja saponin to the powdered material, where the quillaja saponin is prepared from Quillaja saponaria Molina. The quillaja saponin can be applied to the powdered material by a variety of processes, including by adding the saponin as a dry formulation to the powdered material, or by adding the saponin as a liquid formulation to the powdered material.

Also disclosed herein are food additive formulations that include an anti-caking agent (e.g. quillaja saponin and/or potassium cocoate) and a granulated foodstuff. The food additive formulations generally include the anti-caking agent to reduce caking and improve the flowability of the foodstuff. For this purpose, the anti-caking agent is present in the food additive formulations described herein at a concentration of about 10 ppm to about 4000 ppm (e.g. 40 ppm), in some instances.

The methods and formulations disclosed in the present application can also include an anti-foaming agent or step of adding an anti-foaming agent to the foodstuff, where the anti-foaming agent is a hydrophobic material. For example, in some of the formulations, the anti-foaming agent is selected from a hydrophobic emulsifier, a surfactant, a hydrophobic oil (e.g. olive oil, mineral oil, canola oil, and the like), and a hydrophobic solid (e.g. carnauba wax and the like).

The methods and formulations disclosed herein are generally compatible with a wide assortment of powdered materials. For example, in some instances, the methods are used to prepare a foodstuff that includes sodium chloride and demonstrates significantly reduced caking and improved flowability under a variety of conditions. Likewise, in some instances, the food additive formulations described herein include granulated sodium chloride.

### BRIEF DESCRIPTION OF THE DRAWINGS

FIG. 1 shows a histogram that summarizes various performance characteristics for a foodstuff treated with various concentrations of potassium cocoate or quillaja saponin.

FIG. 2 shows a histogram that summarizes various performance characteristics for a foodstuff treated with quillaja saponin, where the quillaja saponin is applied as either a liquid formulation or a dry powder formulation.

FIG. 3 shows a histogram that summarizes various performance characteristics for a foodstuff treated with various concentrations of quillaja saponin and dried under two distinct conditions.

FIG. 4 shows a histogram in the top panel, which summarizes the performance characteristics for a foodstuff treated with a single concentration of quillaja saponin and subsequently dried under five distinct conditions. The bottom panel shows a histogram that summarizes the performance characteristics for a foodstuff that was not treated with quillaja saponin and was subsequently dried under the same conditions.

FIG. 5 shows a histogram that summarizes the performance characteristics for a foodstuff treated with various concentrations of quillaja saponin in comparison to samples additionally treated with an anti-foaming agent.

### DETAILED DESCRIPTION

Saponins are a large class of natural product molecules that include at least 11 subclasses differentiated based upon their structural and physical characteristics. For example, the most common subclass of saponins are the oleananes, which have a triterpenoid, five-ring core structure and are produced by woody angiosperms. Saponins have several common features regardless of their subclass, such as the presence of both hydrophobic and hydrophilic substituents. For example, hydrophobic functional groups present in most saponins include the hydrocarbon rings that form the core of the compound structure. Hydrophilic groups present in many of these natural products include sugar chains. Thus, saponins are characterized as being amphoteric in nature and are, therefore, naturally derived surfactants. The inventors have discovered that saponins are useful as anticaking agents that improve the flowability of a foodstuff. Described herein are methods for reducing the caking and improving the flowability of a powdered material, such as a powdered or granulated foodstuff, as well as food additive formulations that include a saponin and a granulated foodstuff.

### Methods of Reducing Caking and Improving Flowability of a Foodstuff

In one aspect, the present disclosure relates to a method of reducing caking and improving the flowability of a powdered material. In some embodiments, the methods of reducing caking and improving the flowability of a powdered material disclosed herein include adding an anti-caking agent to the powdered material to prepare a treated powdered material, where the anti-caking agent is selected from a saponin and potassium cocoate, and the anti-caking agent is added to the powdered material at a concentration sufficient to reduce the average caking of the powdered material to less than about 40 percent. In some embodiments, the saponin is a quillaja saponin. In some embodiments, the methods of reducing caking and improving the flowability of a powdered material disclosed herein include adding a saponin to the powdered material to prepare a saponin-treated powdered material, where the saponin is added to the powdered material at a concentration sufficient to reduce the average caking of the powdered material to less than about 40 percent. In some embodiments, methods of reducing caking and improving the flowability of a powdered material disclosed herein include adding a quillaja saponin to the powdered material to prepare a saponin-treated powdered material, where the quillaja saponin is added to the powdered material at a concentration sufficient to reduce the average caking of the powdered material to less than about 40 percent.

The identity and nature of the powdered material for which caking can be reduced and flowability improved is not particularly limited, provided that the powdered material is compatible with the anti-caking agent (e.g. saponin and/or potassium cocoate) used in the methods described herein. For example, in some embodiments, the powdered material is a foodstuff. In some embodiments, the powdered material is a detergent powder. In some embodiments, the powdered material is a pharmaceutical. In some embodiments, the powdered material is a bulk chemical powder.

The quillaja saponin to be added to the powdered material can be obtained from any appropriate source. For example, in some embodiments, the quillaja saponin is obtained from Quillaja saponaria Molina, also known as soap bark tree. In certain embodiments, the quillaja saponin is provided as an extract prepared from Quillaja saponaria, where the extract contains one or more than one saponins present within the Quillaja saponaria. In certain other embodiments, the quillaja saponin may be provided as Ingredion™ Q-Naturale® 200V Quillaja saponaria, extracts.

In some embodiments, the quillaja saponin includes a compound selected from:

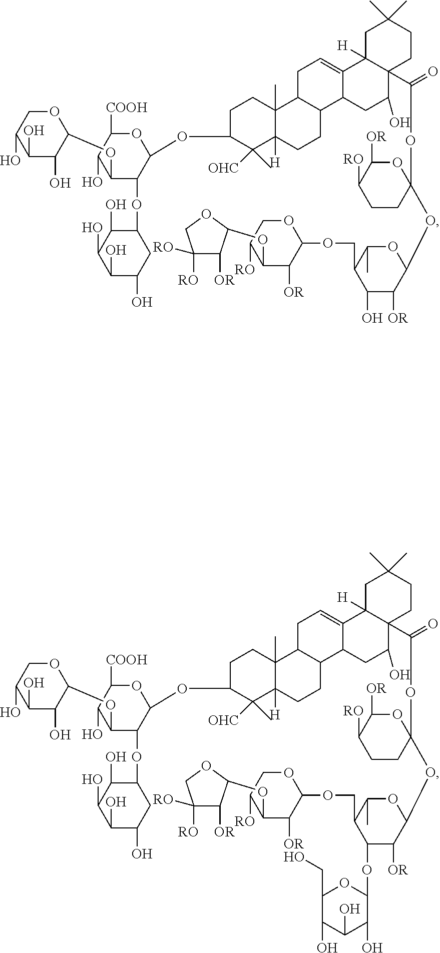

and and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

In certain embodiments, the quillaja saponin includes the compound:

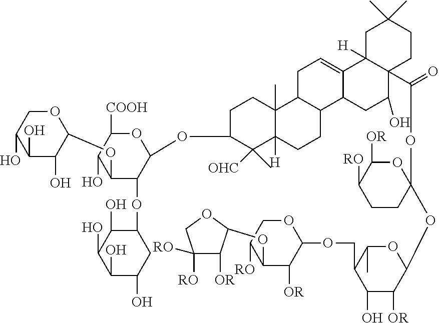

and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

In other embodiments, the quillaja saponin includes the compound:

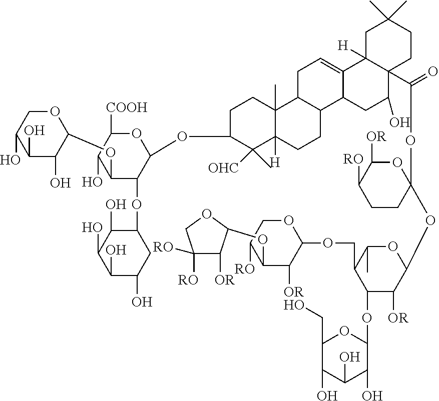

and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

Saponins isolated from other biological sources are also compatible with the methods and formulations disclosed herein. Non-limiting examples of other sources for saponins include horse-chestnuts, sugar beets, chickpeas, soy beans, ivy, Chinese ginseng, green pea, primula, soapwort, fenugreek, oat, quinoa, saffron crocus, licorice root, alfalfa, American ginseng, milk wort, sarsaparilla, and yucca. In some embodiments, saponins isolated from horse-chestnuts can be used in place of the quillaja saponin. In some embodiments, saponins isolated from sugar beets can be used in place of the quillaja saponin. In some embodiments, saponins isolated from chickpeas can be used in place of the quillaja saponin. In some embodiments, saponins isolated from soy beans can be used in place of the quillaja saponin. In some embodiments, saponins isolated from ivy can be used in place of the quillaja saponin. In some embodiments, saponins isolated from Chinese ginseng can be used in place of the quillaja saponin. In some embodiments, saponins isolated from green peas can be used in place of the quillaja saponin. In some embodiments, saponins isolated from primula can be used in place of the quillaja saponin. In some embodiments, saponins isolated from soap wort can be used in place of the quillaja saponin. In some embodiments, saponins isolated from fenugreek can be used in place of the quillaja saponin. In some embodiments, saponins isolated from oat can be used in place of the quillaja saponin. In some embodiments, saponins isolated from quinoa can be used in place of the quillaja saponin. In some embodiments, saponins isolated from saffron crocus can be used in place of the quillaja saponin. In some embodiments, saponins isolated from licorice root can be used in place of the quillaja saponin. In some embodiments, saponins isolated from alfalfa can be used in place of the quillaja saponin. In some embodiments, saponins isolated from American ginseng can be used in place of the quillaja saponin. In some embodiments, saponins isolated from milk wort can be used in place of the quillaja saponin. In some embodiments, saponins isolated from sarsaparilla can be used in place of the quillaja saponin. In some embodiments, saponins isolated from yucca can be used in place of the quillaja saponin.

It will be appreciated that of the saponins compatible with the methods described herein, numerous semi-synthetic derivatives of such saponins may also be known or readily conceived by one of ordinary skill in the art. For example, such semi-synthetic derivatives can include, but are not limited to, alkylated (e.g. methylated or ethylated), halogenated, oxidized (e.g. transformation of a hydroxyl group to an aldehyde, ketone, or carboxylic acid), reduced (e.g. conversion of a carboxylic acid, ketone, or aldehyde to a hydroxyl group), or amidated derivatives of naturally-derived saponins. Likewise, such semi-synthetic derivatives can also include derivatives that contain additional sugar groups, lack particular sugar groups, or contain modified sugar groups. These semi-synthetic saponin derivatives are within the scope of the presently described invention and may be useful within the methods and formulations described herein.

In some embodiments, the anti-caking agent is added to the powdered material at a concentration sufficient to reduce the average caking of the powdered material to less than about 40%. For example, the anti-caking agent can be added to the powdered material at a concentration sufficient to reduce the average caking of the powdered material to less than about 40%, about 35%, about 30%, about 25%, about 20%, about 15%, about 10%, about 9%, about 8%, about 7%, about 6%, about 5%, about 4%, about 3%, about 2%, or about 1%. In some embodiments, the anti-caking agent is added to the powdered material at a concentration sufficient to reduce the average caking of the powdered material to less than about 30%. In certain embodiments, the anti-caking agent is added to the powdered material at a concentration sufficient to reduce the average caking of the powdered material to less than about 20%. In other embodiments, the anti-caking agent is added to the powdered material at a concentration sufficient to reduce the average caking of the powdered material to less than about 10%. In some embodiments, the anti-caking agent is selected from potassium cocoate, quillaja saponin, and combinations thereof. In some embodiments, the anti-caking agent is potassium cocoate. In some embodiments, the anti-caking agent is quillaja saponin.

In some embodiments, the saponin is added to the powdered material at a concentration sufficient to reduce the average caking of the powdered material to less than about 40%. For example, the saponin can be added to the powdered material at a concentration sufficient to reduce the average caking of the powdered material to less than about 40%, about 35%, about 30%, about 25%, about 20%, about 15%, about 10%, about 9%, about 8%, about 7%, about 6%, about 5%, about 4%, about 3%, about 2%, or about 1%. In some embodiments, the saponin is added to the powdered material at a concentration sufficient to reduce the average caking of the powdered material to less than about 30%. In certain embodiments, the saponin is added to the powdered material at a concentration sufficient to reduce the average caking of the powdered material to less than about 20%. In other embodiments, the saponin is added to the powdered material at a concentration sufficient to reduce the average caking of the powdered material to less than about 10%. In certain embodiments, the saponin is a quillaja saponin.

Those of ordinary skill in the art will appreciate that the average caking of the powdered material can be assessed by a variety of different methods. In certain embodiments, the average caking of the powdered material is assessed via the methods disclosed herein (e.g. the methods described in Example 1).

In some embodiments of the methods disclosed herein, the anti-caking agent is added at a concentration sufficient to reduce the average crust thickness of caking within the powdered material to less than about 10 mm. For example, the anti-caking agent can be added to the powdered material at a concentration sufficient to reduce the average crust thickness of caking within the powdered material to less than about 10 mm, about 9 mm, about 8 mm, about 7 mm, about 6 mm, about 5 mm, about 4 mm, about 3 mm, about 2 mm, or about 1 mm. In some embodiments, the anti-caking agent is selected from potassium cocoate, quillaja saponin, and combinations thereof. In some embodiments, the anti-caking agent is potassium cocoate. In some embodiments, the anti-caking agent is quillaja saponin.

In some embodiments of the methods disclosed herein, the saponin is added at a concentration sufficient to reduce the average crust thickness of caking within the powdered material to less than about 10 mm. For example, the saponin can be added to the powdered material at a concentration sufficient to reduce the average crust thickness of caking within the powdered material to less than about 10 mm, about 9 mm, about 8 mm, about 7 mm, about 6 mm, about 5 mm, about 4 mm, about 3 mm, about 2 mm, or about 1 mm. In certain embodiments, the saponin is a quillaja saponin.

In some embodiments of the methods disclosed herein, the anti-caking agent is added at a concentration sufficient to reduce the average crust thickness of caking within the powdered material by about 5% to about 80%, as compared to an untreated sample of the powdered material. For example, the anti-caking agent can be added to the powdered material at a concentration sufficient to reduce the average crust thickness of caking within the powdered material by about 5%, about 10%, about 15%, about 20%, about 25%, about 30%, about 35%, about 40%, about 45%, about 50%, about 55%, about 60%, about 65%, about 70%, about 75%, or about 80%, as compared to an untreated sample of the powdered material. In some embodiments of the methods disclosed herein, the anti-caking agent is added at a concentration sufficient to reduce the average crust thickness of caking within the powdered material by about 20% to about 60%, as compared to an untreated sample of the powdered material. In some embodiments, the anti-caking agent is selected from potassium cocoate, a quillaja saponin, and combinations thereof. In some embodiments, the anti-caking agent is potassium cocoate. In some embodiments, the anti-caking agent is a quillaja saponin.

In some embodiments of the methods disclosed herein, the saponin is added at a concentration sufficient to reduce the average crust thickness of caking within the powdered material by about 5% to about 80%, as compared to an untreated sample of the powdered material. For example, the saponin can be added to the powdered material at a concentration sufficient to reduce the average crust thickness of caking within the powdered material by about 5%, about 10%, about 15%, about 20%, about 25%, about 30%, about 35%, about 40%, about 45%, about 50%, about 55%, about 60%, about 65%, about 70%, about 75%, or about 80%, as compared to an untreated sample of the powdered material. In some embodiments of the methods disclosed herein, the saponin is added at a concentration sufficient to reduce the average crust thickness of caking within the powdered material by about 20% to about 60%, as compared to an untreated sample of the powdered material. In certain embodiments, the saponin is a quillaja saponin.

Those of ordinary skill in the art will appreciate that the average crust thickness of the powdered material can be assessed by a variety of different methods. In certain embodiments, the average crust thickness of caking within the powdered material is assessed via the methods disclosed herein (e.g. the methods described in Example 1).

In some embodiments of the methods disclosed herein, the concentration of anti-caking agent added to the powdered material is about 10 ppm to about 4000 ppm. For example, in some embodiments, the concentration of anti-caking agent added to the powdered material is about 4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the methods disclosed herein, the concentration of anti-caking agent added to the powdered material is about 10 ppm to about 400 ppm. For example, in some embodiments, the concentration of anti-caking agent added to the powdered material is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of anti-caking agent added to the powdered material is about 400 ppm. In certain other embodiments, the concentration of anti-caking added to the powdered material is about 200 ppm. In certain embodiments, the concentration of anti-caking agent added to the powdered material is about 80 ppm. In certain embodiments, the concentration of anti-caking agent added to the powdered material is about 40 ppm. In certain other embodiments, the concentration of anti-caking agent added to the powdered material is about 50 ppm. In certain embodiments, the concentration of anti-caking agent added to the powdered material is about 10 ppm. In some embodiments, the anti-caking agent is selected from potassium cocoate, a quillaja saponin, and combinations thereof. In some embodiments, the anti-caking agent is potassium cocoate. In some embodiments, the anti-caking agent is a quillaja saponin.

In some embodiments of the methods disclosed herein, the concentration of saponin added to the powdered material is about 10 ppm to about 4000 ppm. For example, in some embodiments, the concentration of saponin added to the powdered material is about 4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the methods disclosed herein, the concentration of saponin added to the powdered material is about 10 ppm to about 400 ppm. For example, in some embodiments, the concentration of saponin added to the powdered material is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of saponin added to the powdered material is about 400 ppm. In certain other embodiments, the concentration of saponin added to the powdered material is about 200 ppm. In certain embodiments, the concentration of saponin added to the powdered material is about 80 ppm. In certain embodiments, the concentration of saponin added to the powdered material is about 40 ppm. In certain other embodiments, the concentration of saponin added to the powdered material is about 50 ppm. In certain embodiments, the concentration of saponin added to the powdered material is about 10 ppm.

In some embodiments of the methods disclosed herein, the concentration of quillaja saponin added to the powdered material is about 10 ppm to about 4000 ppm. For example, in some embodiments, the concentration of quillaja saponin added to the powdered material is about 4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the methods disclosed herein, the concentration of quillaja saponin added to the powdered material is about 10 ppm to about 400 ppm. For example, in some embodiments, the concentration of quillaja saponin added to the powdered material is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of quillaja saponin added to the powdered material is about 400 ppm. In certain other embodiments, the concentration of quillaja saponin added to the powdered material is about 200 ppm. In certain embodiments, the concentration of quillaja saponin added to the powdered material is about 80 ppm. In certain embodiments, the concentration of quillaja saponin added to the powdered material is about 40 ppm. In certain other embodiments, the concentration of quillaja saponin added to the powdered material is about 50 ppm. In certain embodiments, the concentration of quillaja saponin added to the powdered material is about 10 ppm.

The step of adding the anti-caking agent to the powdered material can be achieved via any appropriate process. For example, in some embodiments, the anti-caking agent is added to the powdered material by dry blending the anti-caking agent, provided as a dry powder formulation, with the powdered material. In such embodiments, the dry blending can be performed with any compatible industrial mixer commonly known to those of ordinary skill in the art. In other embodiments, the anti-caking agent is added to the powdered material as a liquid formulation via any appropriate process, such as by spraying the powdered material with the liquid formulation of anti-caking agent. In such embodiments, the liquid formulation of anti-caking agent can be sprayed on to the powdered material using any appropriate system commonly known to those of ordinary skill, such as via a pressurized nozzle. The powdered material can be blended by any appropriate process, such as through the use of a paddle mixer, a nauta mixer, a ribbon blender, a batch mixer, or a screw conveyer, as the powdered material is sprayed with the liquid formulation.

The step of adding the saponin to the powdered material can be achieved via any appropriate process. For example, in some embodiments, the saponin is added to the powdered material by dry blending the saponin, provided as a dry powder formulation, with the powdered material. In such embodiments, the dry blending can be performed with any compatible industrial mixer commonly known to those of ordinary skill in the art. In other embodiments, the saponin is added to the powdered material as a liquid formulation via any appropriate process, such as by spraying the powdered material with the liquid formulation of saponin. In such embodiments, the liquid formulation of saponin can be sprayed on to the powdered material using any appropriate system commonly known to those of ordinary skill, such as via a pressurized nozzle. In certain embodiments, the saponin is a quillaja saponin. The powdered material can be blended by any appropriate process, such as through the use of a paddle mixer, a nauta mixer, a ribbon blender, a batch mixer, or a screw conveyer, as the powdered material is sprayed with the liquid formulation.

In some embodiments, the saponin can be added to the powdered material at high concentrations to produce a mother batch of saponin-treated powdered material, where the mother batch of saponin-treated powdered material is subsequently blended with a quantity of untreated powdered material to produce a final batch of saponin-treated powdered material with a reduced concentration of saponin. In certain embodiments, the final concentration of the saponin in the final batch of saponin-treated powdered material is about 5 ppm to about 200 ppm of dry saponin by weight. For example, in certain embodiments, the final concentration of the saponin in the final batch of saponin-treated powdered material is about 5 ppm, about 25 ppm, about 50 ppm, about 75 ppm, about 100 ppm, about 125 ppm, about 150 ppm, about 175 ppm, or about 200 ppm of dry saponin by weight.

In certain embodiments, the mother batch of saponin-treated powdered material is prepared by dry blending a powdered formulation of the saponin with the powdered material.

In certain embodiments, the mother batch of saponin-treated powdered material is prepared by spraying the powdered material with a liquid formulation of the saponin.

In some embodiments, the liquid formulation of the saponin is an aqueous formulation of the saponin. In some embodiments, the aqueous formulation of the saponin includes the saponin at a concentration of about 10% to about 30% by weight. In some embodiments, the aqueous formulation of the saponin includes the saponin at a concentration of about 20% by weight.

In some embodiments, the liquid formulation of the saponin is applied to the powdered material to produce a mother batch of saponin-treated powdered material, where the mother batch of saponin-treated powdered material includes about 2.5% to about 10% of the liquid saponin formulation by weight. In some embodiments, the liquid formulation of the saponin is applied to the powdered material to produce a mother batch of saponin-treated powdered material, where the mother batch of saponin-treated powdered material includes about 2.5% to about 10% of the liquid saponin formulation by weight, such that the mother batch of saponin-treated powdered material includes about 0.25% to about 3% dry saponin by weight. In some embodiments, the liquid formulation of the saponin is applied to the powdered material to produce a mother batch of saponin-treated powdered material, where the mother batch of saponin-treated powdered material includes about 2.5% to about 10% of the liquid saponin formulation by weight, such that the mother batch of saponin-treated powdered material includes about 0.5% to about 2% dry saponin by weight.

In some embodiments, the mother batch of saponin-treated powdered material is subsequently dried following an application of the liquid saponin formulation. In certain embodiments, the mother batch of saponin-treated powdered material is dried naturally at atmospheric temperature and pressure. In certain other embodiments, the mother batch of saponin-treated powdered material is dried via heating the mother batch to an elevated temperature. In certain other embodiments, the mother batch of saponin-treated powdered material is dried via heating the mother batch to an elevated temperature in a forced convection oven. In some embodiments, the elevated temperature is about 30° C. to about 100° C. For example, in some embodiments, the elevated temperature is about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C. In some embodiments, the mother batch of saponin-treated powdered material is dried via a spray drier. In some embodiments, the mother batch of saponin-treated powdered material is ground or milled after drying, for example, to reduce particle size. In some embodiments, the methods of reducing caking and improving the flowability of a powdered material described herein can further include the step of drying the saponin-treated powdered material. The process, method, or system for drying the saponin-treated powdered material is not particularly limited, and the drying may be achieved using any appropriate process, method, or system commonly known to those of ordinary skill in the art.

In some embodiments, the step of drying the saponin-treated powdered material includes heating the saponin-treated powdered material. In certain embodiments, the step of drying the saponin-treated powdered material includes heating the saponin-treated powdered material to a temperature of about 25° C. to about 105° C. For example, in certain embodiments, the saponin-treated powdered material is heated to a temperature of about 105° C., 100° C., 95° C., 90° C., 85° C., 80° C., 75° C., 70° C., 65° C., 60° C., 55° C., 50° C., 45° C., 40° C., 35° C., 30° C., or 25° C. In certain embodiments, the saponin-treated powdered material is dried by heating the saponin-treated powdered material to a temperature of about 105° C. In certain other embodiments, the saponin-treated powdered material is dried by heating the saponin-treated powdered material to a temperature of about 65° C. In certain other embodiments, the saponin-treated powdered material is dried by heating the saponin-treated powdered material to a temperature of about 50° C. In certain other embodiments, the saponin-treated powdered material is dried by heating the saponin-treated powdered material to a temperature of about 40° C. In certain other embodiments, the saponin-treated powdered material is dried by heating the saponin-treated powdered material to a temperature of about 25° C. In certain other embodiments, the saponin-treated powdered material is dried by heating the saponin-treated powdered material to a temperature of about 25° C. and a relative humidity of about 40%.

In some embodiments, the methods of reducing caking and improving the flowability of a powdered material described herein can further include the step of adding an anti-foaming agent to the powdered material. In some embodiments, the methods of reducing caking and improving the flowability of a powdered material described herein can further include the step of adding an anti-foaming agent to the powdered material, where the anti-foaming agent is a naturally-derived anti-foaming agent. In some embodiments, the methods of reducing caking and improving the flowability of a powdered material described herein can further include the step of adding an anti-foaming agent to the saponin-treated powdered material. In certain embodiments, the step of adding an anti-foaming agent to the powdered material or the saponin-treated powdered material includes mixing the anti-foaming agent with the powdered material or the saponin-treated powdered material, or a solution including the powdered material or the saponin-treated powdered material. In such embodiments, mixing the anti-foaming agent with the powdered material or the saponin-treated powdered material can be performed for any appropriate amount of time, such as about 1 minute to about 30 minutes. In certain embodiments, mixing the anti-foaming agent is performed for about 10 minutes.

In some embodiments, the addition of the anti-foaming agent to the powdered material unexpectedly further reduces caking within the powdered material and further improves the flowability of the powdered material, as compared to a sample of the powdered material treated with the anti-caking agent (e.g. saponin and/or potassium cocoate) or anti-foaming agent alone. In other words, in some embodiments, the anti-foaming agent acts synergistically with the anti-caking agent to reduce caking within the powdered material and to improve the flowability of the powder material to a greater extent than is achieved following treatment with either the saponin or anti-foaming agent alone.

The step of adding an anti-foaming agent to the powdered material or the saponin-treated powdered material can include adding any appropriate anti-foaming agent capable of reducing foaming within a solution that includes dissolved saponin-treated powdered material. Without being bound to theory, under certain conditions, saponin may function as a non-ionic surfactant, resulting in foaming within a solution that includes a dissolved saponin-treated powdered material. The addition of the anti-foaming agent reduces foaming within such solutions and can be used to extend the number of situations in which the saponin-treated powdered material can be appropriately used. In certain embodiments, the anti-foaming agent is a hydrophobic anti-foaming agent. In certain embodiments, the anti-foaming agent is a hydrophobic anti-foaming agent, where the hydrophobic anti-foaming agent is provided at a maximum concentration of about 25 ppm to about 20,000 ppm (i.e. about 2% by weight). In certain embodiments, the addition of the anti-foaming agent to a solution of dissolved saponin-treated powdered material does not result in a change in the appearance of the solution.

In some embodiments, the anti-foaming agent is a hydrophobic anti-foaming agent selected from an emulsifier, a surfactant, a hydrophobic oil, and a hydrophobic solid. In other embodiments, the anti-foaming agent is a hydrophobic anti-foaming agent selected from an oil, a wax, a polysorbate, an optionally modified polysaccharide, a fatty acid, and a phosphate salt. In some embodiments, the anti-foaming agent is selected from olive oil, coconut oil, potassium cocoate, canola oil, mineral oil, carnauba wax, hydroxypropyl methyl cellulose, polysorbate 80, calcium stearate, and sodium laurylglucosides hydroxypropylsulfonate (e.g. SugaNate™ and the like). In the embodiments where the powdered material is not a foodstuff (e.g. detergent powders, bulk chemical powders, and pharmaceuticals), the anti-foaming agent can also be selected from mineral oil, glycols (e.g. polyethylene glycol), organosilicone compounds, and the like.

In certain embodiments, the anti-foaming agent is olive oil. In certain embodiments, the anti-foaming agent is olive oil, where the olive oil is provided at a concentration of about 0.1%. In certain embodiments, the anti-foaming agent is olive oil, where the olive oil is provided at a concentration of about 0.2%. In certain embodiments, the anti-foaming agent is olive oil, where the olive oil is provided at a concentration of about 400 ppm to about 2000 ppm. For example, in some embodiments, the olive oil is provided at a concentration of about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, or about 400 ppm.

In certain embodiments, the anti-foaming agent is coconut oil. In certain embodiments, the anti-foaming agent is coconut oil, where the coconut oil is provided at a concentration of about 50 ppm to about 1000 ppm. In certain embodiments, the anti-foaming agent is coconut oil, where the coconut oil is provided at a concentration of about 0.1%. In certain embodiments, the anti-foaming agent is coconut oil, where the coconut oil is provided at a concentration of about 400 ppm. In certain embodiments, the anti-foaming agent is coconut oil, where the coconut oil is provided at a concentration of about 600 ppm. In some embodiments, the coconut oil demonstrates a synergistic effect with the anti-caking agent.

In certain embodiments, the anti-foaming agent is potassium cocoate. In certain embodiments, the anti-foaming agent if potassium cocoate, where the potassium cocoate is provided at a concentration of about 50 ppm to about 1000 ppm. In certain embodiments, the anti-foaming agent if potassium cocoate, where the potassium cocoate is provided at a concentration of about 100 ppm.

In certain embodiments, the anti-foaming agent is canola oil. In certain embodiments, the anti-foaming agent is canola oil, where the canola oil is provided at a concentration of about 50 ppm to about 1000 ppm. In certain embodiments, the anti-foaming agent is canola oil, where the canola oil is provided at a concentration of about 100 ppm. In certain embodiments, the anti-foaming agent is canola oil, where the canola oil is provided at a concentration of about 600 ppm.

In certain embodiments, the anti-foaming agent is mineral oil. In certain embodiments, the anti-foaming agent is mineral oil, where the mineral oil is provided at a concentration of about 50 ppm to about 1000 ppm. In certain embodiments, the anti-foaming agent is mineral oil, where the mineral oil is provided at a concentration of about 600 ppm.

In certain embodiments, the anti-foaming agent is carnauba wax. In certain embodiments, the anti-foaming agent is carnauba wax, where the carnauba was is provided at a concentration of about 50 ppm to about 1000 ppm. In certain embodiments, the anti-foaming agent is carnauba wax, where the carnauba was is provided at a concentration of about 200 ppm to about 600 ppm. In certain embodiments, the anti-foaming agent is carnauba wax, where the carnauba was is provided at a concentration of about 600 ppm. In certain embodiments, the anti-foaming agent is carnauba wax, where the carnauba was is provided at a concentration of about 300 ppm. In certain embodiments, the anti-foaming agent is carnauba wax, where the carnauba wax is provided at a concentration of about 200 ppm.

In certain embodiments, the anti-foaming agent is hydroxypropyl methyl cellulose. In certain embodiments, the anti-foaming agent is hydroxypropyl methyl cellulose, where the hydroxypropyl methyl cellulose is provided at a concentration of about 50 ppm to about 1000 ppm. In certain embodiments, the anti-foaming agent is hydroxypropyl methyl cellulose, where the hydroxypropyl methyl cellulose is provided at a concentration of about 400 ppm.

In certain embodiments, the anti-foaming agent is polysorbate 80. In certain embodiments, the anti-foaming agent is polysorbate 80, where the polysorbate 80 is provided at a concentration of about 50 ppm to about 1000 ppm. In certain embodiments, the anti-foaming agent is polysorbate 80, where the polysorbate 80 is provided at a concentration of about 600 ppm.

In certain embodiments, the anti-foaming agent is calcium stearate. In certain embodiments, the anti-foaming agent is calcium stearate, where the calcium stearate is provided at a concentration of about 50 ppm to about 1000 ppm. In certain embodiments, the anti-foaming agent is calcium stearate, where the calcium stearate is provided at a concentration of about 400 ppm.

In certain embodiments, the anti-foaming agent is sodium laurylglucoside hydroxypropylsulfonate. In certain embodiments, the anti-foaming agent is sodium laurylglucosides hydroxypropylsulfonate, where the sodium laurylglucoside hydroxypropylsulfonate is provided at a concentration of about 400 ppm. In certain embodiments, the sodium laurylglucoside hydroxypropylsulfonate is provided as SugaNate™ (Colonial Chemicals).

In some embodiments, the steps of adding an anti-caking agent (e.g. a quillaja saponin and/or potassium cocoate) to the powdered material and adding anti-foaming agent to the powdered material can be performed concurrently, for example by adding a single composition or formulation that includes both the quillaja saponin and the anti-foaming agent. In other embodiments, the anti-foaming agent is added to the anti-caking agent-treated powdered material. In other words, the anti-foaming agent is added to the powdered material after the anti-caking agent has been added in some embodiments of the methods described herein. In other embodiments, the anti-foaming agent is added to the powdered material prior to the addition of the anti-caking agent to the powdered material.

The methods of reducing caking and improving flowability of a foodstuff disclosed herein are generally compatible with dry ingredients and the like. In some embodiments, the foodstuff is a granulated foodstuff. In some embodiments, the foodstuff includes sodium chloride. In some embodiments, the foodstuff is granulated sodium chloride. In some embodiments, the foodstuff consists essentially of sodium chloride. In some embodiments, the foodstuff consists of sodium chloride. In other embodiments, the foodstuff may include one or more foodstuffs selected from sodium chloride, baking soda, granulated sugar, brown sugar, baking powder, flour, seasonings, and the like.

### Food Additive Formulations of the Disclosure

In another aspect, the present disclosure relates to a food additive formulation that includes an anti-caking agent and demonstrates reduced caking and improved flowability compared to a comparable formulation free of the anti-caking agent, where the anti-caking agent is selected from potassium cocoate, a saponin, and combinations thereof. In some embodiments, the saponin is a quillaja saponin. In some embodiments, the anti-caking agent is present at a concentration of about 10 ppm to about 400 ppm. In another aspect, the present disclosure relates to a food additive formulation that includes a saponin and demonstrates reduced caking and improved flowability compared to a comparable formulation free of the saponin. In some embodiments, the present disclosure relates to a food additive formulation that includes a quillaja saponin and a granulated foodstuff. In certain embodiments, the present disclosure relates to a food-additive formulation that includes a quillaja saponin and a granulated foodstuff, where the quillaja saponin is present in the formulation at a concentration of about 10 ppm to about 400 ppm, and where the quillaja saponin is for reducing the caking of the granulated foodstuff and for improving the flowability of the granulated foodstuff.

The quillaja saponin present in the food additive formulations disclosed herein can be obtained from any appropriate source. For example, in some embodiments, the quillaja saponin is obtained from Quillaja saponaria Molina. In certain embodiments, the quillaja saponin is provided as an extract prepared from Quillaja saponaria, where the extract contains one or more than one saponins present within the Quillaja saponaria. In certain other embodiments, the quillaja saponin may be provided as Ingredion™ Q-Naturale® 200V Quillaja saponaria, extracts.

In some embodiments, the quillaja saponin present in the food additive formulation includes a compound selected from:

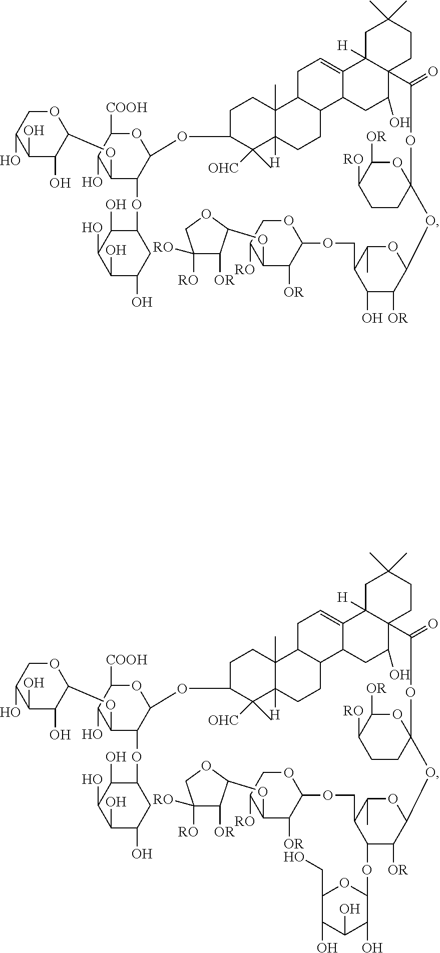

and and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

In certain embodiments, the quillaja saponin included in the food additive formulation includes the compound:

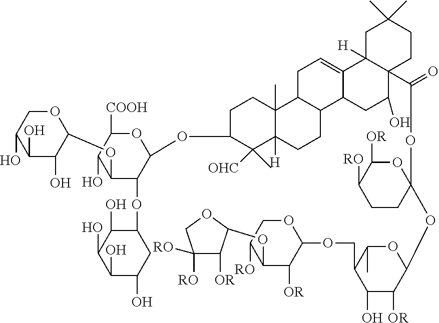

and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

In other embodiments, the quillaja saponin included in the food additive formulation includes the compound:

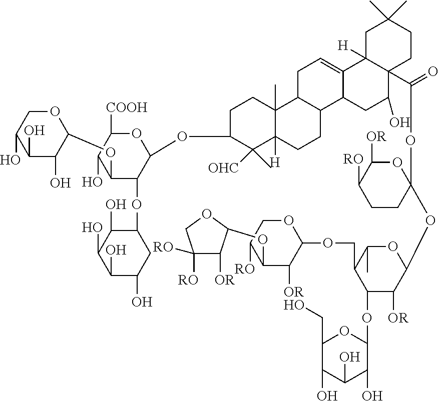

and combinations thereof, or a hydrate, solvate, tautomer, stereoisomer, or salt thereof, where each R is independently selected from: —H, —CH₃, or —COOH. In some embodiments, one or more R is —H. In other embodiments, one or more R is —CH₃. In other embodiments, one or more R is —COOH.

Saponins isolated from other biological sources are also compatible with the formulations disclosed herein. Non-limiting examples of other sources for saponins for use within the food additive formulations include horse-chestnuts, sugar beets, chickpeas, soy beans, ivy, Chinese ginseng, green pea, primula, soapwort, fenugreek, oat, quinoa, saffron crocus, licorice root, alfalfa, American ginseng, milk wort, sarsaparilla, and yucca. In some embodiments, saponins isolated from horse-chestnuts can be used in place of the quillaja saponin within the food additive formulation. In some embodiments, saponins isolated from sugar beets can be used in place of the quillaja saponin within the food additive formulation. In some embodiments, saponins isolated from chickpeas can be used in place of the quillaja saponin within the food additive formulation. In some embodiments, saponins isolated from soy beans can be used in place of the quillaja saponin within the food additive formulation. In some embodiments, saponins isolated from ivy can be used in place of the quillaja saponin within the food additive formulation. In some embodiments, saponins isolated from Chinese ginseng can be used in place of the quillaja saponin within the food additive formulation. In some embodiments, saponins isolated from green peas can be used in place of the quillaja saponin within the food additive formulation. In some embodiments, saponins isolated from primula can be used in place of the quillaja saponin within the food additive formulation. In some embodiments, saponins isolated from soap wort can be used in place of the quillaja saponin within the food additive formulation. In some embodiments, saponins isolated from fenugreek can be used in place of the quillaja saponin within the food additive formulation. In some embodiments, saponins isolated from oat can be used in place of the quillaja saponin within the food additive formulation. In some embodiments, saponins isolated from quinoa can be used in place of the quillaja saponin within the food additive formulation. In some embodiments, saponins isolated from saffron crocus can be used in place of the quillaja saponin within the food additive formulation. In some embodiments, saponins isolated from licorice root can be used in place of the quillaja saponin within the food additive formulation. In some embodiments, saponins isolated from alfalfa can be used in place of the quillaja saponin within the food additive formulation. In some embodiments, saponins isolated from American ginseng can be used in place of the quillaja saponin within the food additive formulation. In some embodiments, saponins isolated from milk wort can be used in place of the quillaja saponin within the food additive formulation. In some embodiments, saponins isolated from sarsaparilla can be used in place of the quillaja saponin within the food additive formulation. In some embodiments, saponins isolated from yucca can be used in place of the quillaja saponin within the food additive formulation.

It will be appreciated that of the saponins compatible with the food additive formulations described herein, numerous semi-synthetic derivatives of such saponins may also be known or readily conceived by one of ordinary skill in the art. For example, such semi-synthetic derivatives can include, but are not limited to, alkylated (e.g. methylated or ethylated), halogenated, oxidized (e.g. transformation of a hydroxyl group to an aldehyde, ketone, or carboxylic acid), reduced (e.g. conversion of a carboxylic acid, ketone, or aldehyde to a hydroxyl group), or amidated derivatives of naturally-derived saponins. Likewise, such semi-synthetic derivatives can also include derivatives that contain additional sugar groups, lack particular sugar groups, or contain modified sugar groups. These semi-synthetic saponin derivatives are within the scope of the presently described invention and may be useful within the food additive formulations described herein.

In some embodiments of the formulations disclosed herein, the concentration of anti-caking agent present in the food additive formulation is about 10 ppm to about 4000 ppm. For example, in some embodiments, the concentration of anti-caking agent present in the food additive formulation is about 4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the formulations disclosed herein, the concentration of anti-caking agent present in the food additive formulation is about 10 ppm to about 400 ppm. For example, in some embodiments, the concentration of anti-caking agent present in the food additive formulation is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of anti-caking agent present in the food additive formulation is about 400 ppm. In certain other embodiments, the concentration of anti-caking agent present in the food additive formulation is about 200 ppm. In certain other embodiments, the concentration of anti-caking agent present in the food additive formulation is about 80 ppm. In certain other embodiments, the concentration of anti-caking agent present in the food additive formulation is about 50 ppm. In certain other embodiments, the concentration of anti-caking agent present in the food additive formulation is about 50 ppm. In certain other embodiments, the concentration of anti-caking agent present in the food additive formulation is about 10 ppm.

In some embodiments of the formulations disclosed herein, the concentration of saponin present in the food additive formulation is about 10 ppm to about 4000 ppm. For example, in some embodiments, the concentration of saponin present in the food additive formulation is about

4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the formulations disclosed herein, the concentration of saponin present in the food additive formulation is about 10 ppm to about 400 ppm. For example, in some embodiments, the concentration of saponin present in the food additive formulation is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of saponin present in the food additive formulation is about 400 ppm. In certain other embodiments, the concentration of saponin present in the food additive formulation is about 200 ppm. In certain other embodiments, the concentration of saponin present in the food additive formulation is about 80 ppm. In certain other embodiments, the concentration of saponin present in the food additive formulation is about 50 ppm. In certain other embodiments, the concentration of saponin present in the food additive formulation is about 50 ppm. In certain other embodiments, the concentration of saponin present in the food additive formulation is about 10 ppm.

In some embodiments of the formulations disclosed herein, the concentration of quillaja saponin present in the food additive formulation is about 10 ppm to about 4000 ppm. For example, in some embodiments, the concentration of quillaja saponin present in the food additive formulation is about 4000 ppm, about 3900 ppm, about 3800 ppm, about 3700 ppm, about 3600 ppm, about 3500 ppm, about 3400 ppm, about 3300 ppm, about 3200 ppm, about 3100 ppm, about 3000 ppm, about 2900 ppm, about 2800 ppm, about 2700 ppm, about 2600 ppm, about 2500 ppm, about 2400 ppm, about 2300 ppm, about 2200 ppm about 2100 ppm, about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, about 400 ppm, about 300 ppm, about 200 ppm, or about 100 ppm. In some embodiments of the formulations disclosed herein, the concentration of quillaja saponin present in the food additive formulation is about 10 ppm to about 400 ppm. For example, in some embodiments, the concentration of quillaja saponin present in the food additive formulation is about 400 ppm, about 390 ppm, about 380 ppm, about 370 ppm, about 360 ppm, about 350 ppm, about 340 ppm, about 330 ppm, about 320 ppm, about 310 ppm, about 300 ppm, about 290 ppm, about 280 ppm, about 270 ppm, about 260 ppm, about 250 ppm, about 240 ppm, about 230 ppm, about 220 ppm, about 210 ppm, about 200 ppm, about 190 ppm, about 180 ppm, about 170 ppm, about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, about 30 ppm, about 20 ppm, or about 10 ppm. In certain embodiments, the concentration of quillaja saponin present in the food additive formulation is about 400 ppm. In certain other embodiments, the concentration of quillaja saponin present in the food additive formulation is about 200 ppm. In certain other embodiments, the concentration of quillaja saponin present in the food additive formulation is about 80 ppm. In certain other embodiments, the concentration of quillaja saponin present in the food additive formulation is about 50 ppm. In certain other embodiments, the concentration of quillaja saponin present in the food additive formulation is about 50 ppm. In certain other embodiments, the concentration of quillaja saponin present in the food additive formulation is about 10 ppm.

In some embodiments, the anti-caking agent present in the food additive formulation is provided as a dry powder. In such embodiments, the dry-powder anti-caking agent can be blended with the granulated foodstuff present in the food additive formulation, such that the anti-caking agent is uniformly distributed within the food additive formulation.

In some embodiments, the saponin present in the food additive formulation is provided as a dry powder. In such embodiments, the dry-powder saponin can be blended with the granulated foodstuff present in the food additive formulation, such that the saponin is uniformly distributed within the food additive formulation. In certain embodiments, the saponin is a quillaja saponin.

In other embodiments, the anti-caking agent present in the food additive formulation is provided as a liquid formulation. In such embodiments, the liquid anti-caking agent can be provided to the food additive formulation and applied to the granulated foodstuff by any appropriate process known to those of ordinary skill, such as by spraying the granulated foodstuff with the liquid formulation of anti-caking agent. In these embodiments, the anti-caking agent can be applied to the granulated foodstuff such that it is uniformly distributed within the food additive formulation.

In other embodiments, the saponin present in the food additive formulation is provided as a liquid formulation. In such embodiments, the liquid saponin can be provided to the food additive formulation and applied to the granulated foodstuff by any appropriate process known to those of ordinary skill, such as by spraying the granulated foodstuff with the liquid formulation of saponin. In these embodiments, the saponin can be applied to the granulated foodstuff such that it is uniformly distributed within the food additive formulation. In certain embodiments, the saponin is a quillaja saponin.

In some embodiments, the food additive formulation additionally includes an anti-foaming agent, where the anti-foaming agent can be any agent compatible with the food additive formulation that reduces foaming in a solution in which the food additive formulation has been dissolved (e.g. a solution of the additive dissolved in water). In some embodiments, the anti-foaming agent included in the food additive formulation is a naturally-derived anti-foaming agent. In certain embodiments, the anti-foaming agent included in the food additive formulation is a hydrophobic anti-foaming agent. In certain embodiments, the anti-foaming agent included in the food additive formulation is a hydrophobic anti-foaming agent, where the hydrophobic anti-foaming agent is present in the food additive formulation at a maximum concentration of about 25 ppm to about 20,000 ppm (i.e. 2% by weight). In certain embodiments, the anti-foaming agent included in the food additive formulation is an agent that does not result in a change in the appearance of a solution in which the food additive formulation has been dissolved.

In some embodiments, the anti-foaming agent included in the food additive formulation is a hydrophobic anti-foaming agent selected from an emulsifier, a surfactant, a hydrophobic oil, and a hydrophobic solid. In other embodiments, the anti-foaming agent included in the food additive formulation is a hydrophobic anti-foaming agent selected from an oil, a wax, a polysorbate, an optionally modified polysaccharide, a fatty acid, and a phosphate salt. In some embodiments, the anti-foaming agent included in the food additive formulation is selected from olive oil, coconut oil, potassium cocoate, canola oil, mineral oil, carnauba wax, hydroxypropyl methyl cellulose, polysorbate 80, calcium stearate, and sodium laurylglucoside hydroxypropylsulfonate (e.g. SugaNate™ and the like).

In certain embodiments, the anti-foaming agent included in the food additive formulation is olive oil. In certain embodiments, the anti-foaming agent included in the food additive formulation is olive oil, where the olive oil is present in the food additive formulation at a concentration of about 0.1%. In certain embodiments, the anti-foaming agent included in the food additive formulation is olive oil, where the olive oil is present in the food additive formulation at a concentration of about 0.2%. In certain embodiments, the anti-foaming agent included in the food additive formulation is olive oil, where the olive oil is present in the food additive formulation at a concentration of about 400 ppm to about 2000 ppm. For example, in some embodiments, the olive oil is present in the food additive formulation at a concentration of about 2000 ppm, about 1900 ppm, about 1800 ppm, about 1700 ppm, about 1600 ppm, about 1500 ppm, about 1400 ppm, about 1300 ppm, about 1200 ppm, about 1100 ppm, about 1000 ppm, about 900 ppm, about 800 ppm, about 700 ppm, about 600 ppm, about 500 ppm, or about 400 ppm.

In certain embodiments, the anti-foaming agent included in the food additive formulation is coconut oil. In certain embodiments, the anti-foaming agent is coconut oil, where the coconut oil is present in the food additive formulation at a concentration of about 50 ppm to about 1000 ppm. In certain embodiments, the anti-foaming agent is coconut oil, where the coconut oil is present in the food additive formulation at a concentration of about 0.1%. In certain embodiments, the anti-foaming agent included in the food additive formulation is coconut oil, where the coconut oil is present in the food additive formulation at a concentration of about 400 ppm. In certain embodiments, the anti-foaming agent included in the food additive formulation is coconut oil, where the coconut oil is present in the food additive formulation at a concentration of about 600 ppm.

In certain embodiments, the anti-foaming agent included in the food additive formulation is potassium cocoate. In certain embodiments, the anti-foaming agent included in the food additive formulation is potassium cocoate, where the potassium cocoate is present in the food additive formulation at a concentration of about 50 ppm to about 1000 ppm. In certain embodiments, the anti-foaming agent included in the food additive formulation is potassium cocoate, where the potassium cocoate is present in the food additive formulation at a concentration of about 100 ppm.

In certain embodiments, the anti-foaming agent included in the food additive formulation is canola oil. In certain embodiments, the anti-foaming agent included in the food additive formulation is canola oil, where the canola oil is present in the food additive formulation at a concentration of about 50 ppm to about 1000 ppm. In certain embodiments, the anti-foaming agent included in the food additive formulation is canola oil, where the canola oil is present in the food additive formulation at a concentration of about 100 ppm. In certain embodiments, the anti-foaming agent included in the food additive formulation is canola oil, where the canola oil is present in the food additive formulation at a concentration of about 600 ppm.

In certain embodiments, the anti-foaming agent included in the food additive formulation is mineral oil. In certain embodiments, the anti-foaming agent included in the food additive formulation is mineral oil, where the mineral oil is present in the food additive formulation at a concentration of about 50 ppm to about 1000 ppm. In certain embodiments, the anti-foaming agent included in the food additive formulation is mineral oil, where the mineral oil is present in the food additive formulation at a concentration of about 600 ppm.

In certain embodiments, the anti-foaming agent included in the food additive formulation is carnauba wax. In certain embodiments, the anti-foaming agent included in the food additive formulation is carnauba wax, where the carnauba was is present in the food additive formulation at a concentration of about 50 ppm to about 1000 ppm. In certain embodiments, the anti-foaming agent included in the food additive formulation is carnauba wax, where the carnauba was is present in the food additive formulation at a concentration of about 200 ppm to about 600 ppm. In certain embodiments, the anti-foaming agent included in the food additive formulation is carnauba wax, where the carnauba was is present in the food additive formulation at a concentration of about 600 ppm. In certain embodiments, the anti-foaming agent included in the food additive formulation is carnauba wax, where the carnauba was is present in the food additive formulation at a concentration of about 300 ppm. In certain embodiments, the anti-foaming agent included in the food additive formulation is carnauba wax, where the carnauba wax is present in the food additive formulation at a concentration of about 200 ppm.

In certain embodiments, the anti-foaming agent included in the food additive formulation is hydroxypropyl methyl cellulose. In certain embodiments, the anti-foaming agent included in the food additive formulation is hydroxypropyl methyl cellulose, where the hydroxypropyl methyl cellulose is present in the food additive formulation at a concentration of about 50 ppm to about 1000 ppm. In certain embodiments, the anti-foaming agent included in the food additive formulation is hydroxypropyl methyl cellulose, where the hydroxypropyl methyl cellulose is present in the food additive formulation at a concentration of about 400 ppm.

In certain embodiments, the anti-foaming agent included in the food additive formulation is polysorbate 80. In certain embodiments, the anti-foaming agent included in the food additive formulation is polysorbate 80, where the polysorbate 80 is present in the food additive formulation at a concentration of about 50 ppm to about 1000 ppm. In certain embodiments, the anti-foaming agent included in the food additive formulation is polysorbate 80, where the polysorbate 80 is present in the food additive formulation at a concentration of about 600 ppm.

In certain embodiments, the anti-foaming agent included in the food additive formulation is calcium stearate. In certain embodiments, the anti-foaming agent included in the food additive formulation is calcium stearate, where the calcium stearate is present in the food additive formulation at a concentration of about 50 ppm to about 1000 ppm. In certain embodiments, the anti-foaming agent included in the food additive formulation is calcium stearate, where the calcium stearate is present in the food additive formulation at a concentration of about 400 ppm.

In certain embodiments, the anti-foaming agent included in the food additive formulation is sodium laurylglucoside hydroxypropylsulfonate. In certain embodiments, the anti-foaming agent included in the food additive formulation is sodium laurylglucoside hydroxypropylsulfonate, where the sodium laurylglucoside hydroxypropylsulfonate is present in the food additive formulation at a concentration of about 50 ppm to about 1000 ppm. In certain embodiments, the anti-foaming agent included in the food additive formulation is sodium laurylglucoside hydroxypropylsulfonate, where the sodium laurylglucoside hydroxypropylsulfonate is present in the food additive formulation at a concentration of about 400 ppm. In certain embodiments, the sodium laurylglucoside hydroxypropylsulfonate present in the food additive formulation is provided as SugaNate™ (Colonial Chemicals).

In some embodiments, the granulated foodstuff included in the food additive formulation includes sodium chloride. In some embodiments, the granulated foodstuff includes granulated sodium chloride. In some embodiments, the granulated foodstuff consists essentially of granulated sodium chloride. In some embodiments, the granulated foodstuff consists of granulated sodium chloride. In other embodiments, the granulated foodstuff may include one or more foodstuffs selected from sodium chloride, baking soda, granulated sugar, brown sugar, baking powder, flour, seasonings, and the like.

### EXAMPLES

### Example 1—Comparison of Saponin and Potassium Cocoate as an Anticaking Additive

Samples of granulated sodium chloride treated with either potassium cocoate (100 ppm and 200 ppm) or quillaja saponin (50 ppm and 200 ppm) were prepared by applying the additive in a liquid form to the salt using a pressurized nozzle while mixing the sample with a paddle mixer. After applying the additives, the samples were exposed to 100% relative humidity using an ultrasonic humidifier for two hours. The samples were then dried at 50° C., and the average caking and crust thickness were assessed.

To assess the average caking, the initial weight of the salt sample was measured after the following the humidity exposure and drying step. The sample was then placed on top of a #12-mesh filter to allow free flow to separate from formed cakes. The mass of the free flowing salt was measured. The remaining caked salt was then dropped from a 1-foot height onto the #12-mesh, and the additional free flow was weighed again. The percent of total free flow was calculated by using the initial mass of the sample, and the sum of the mass of the free flow from both free flow measurements. The percentage of sample caking was then calculated by subtracting the percent of total free flow from 100. Multiple replicates can be performed in order to determine the average caking.

Following the drop test to determine average caking of the sample, any remaining caking is isolated, and the crust thickness is measured using a digital caliper. Four measurements are made for each sample, and the collected values averaged to determine the average crust thickness of the sample.

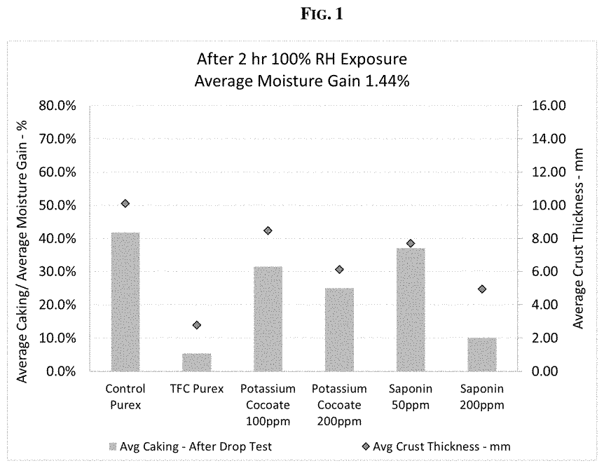

Comparable assessments were also made against a sample of untreated salt (identified as “Control Purex”) and a sample of salt treated with a known anticaking agent, sodium ferrocyanide, which may also be known as Yellow Prussiate of Soda (identified as “TFC Purex”). As shown in FIG. 1, both potassium cocoate and saponin are capable of reducing average caking and crust thickness, relative to the untreated salt sample. The caking observed in the sample treated with 200 ppm was soft caking, meaning that the caking breaks apart upon being picked up or otherwise manipulated with minimal force. In contrast, the caking observed in the Control Purex sample was medium-hard caking, meaning that breaking the cake required significant force.

### Example 2—Comparison of Liquid and Dry Saponin as an Anticaking Additive

Samples of granulated sodium chloride were treated with quillaja saponin (200 ppm) either by dry blending a dry saponin powder with the salt, or by applying a liquid saponin to the salt. In addition to quillaja saponin, the dry powder formulation additionally included maltodextrin. The samples were exposed to high humidity and dried as described above in Example 1. The average caking and crust thickness were then assessed via the protocols described in Example 1.

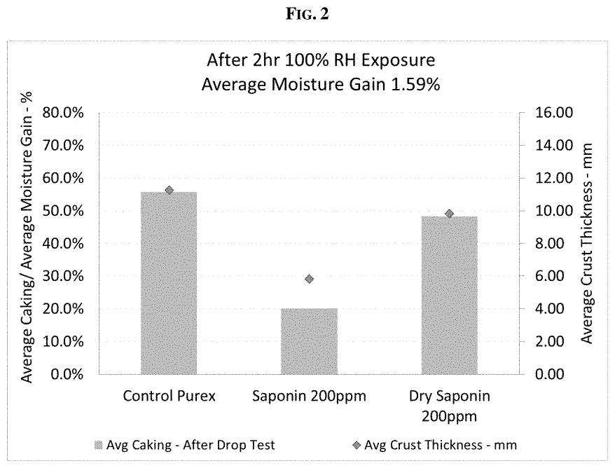

As shown in FIG. 2, the sample treated with liquid or dry saponin demonstrated reductions in average caking and crust thickness, as compared to the Control Purex sample. Additionally, the saponin treated samples demonstrated soft caking, whereas the Control Purex sample demonstrated hard caking.

### Example 3—Comparison of Drying Conditions on the Anticaking Activity of Saponin

Samples treated with liquid quillaja saponin (50 ppm or 200 ppm) were prepared as described above, exposed to high humidity, and dried at a variety of temperatures, including room temperature, 25° C., 40° C., 50° C., 65° C., or 105° C. Some samples were prepared using a paddle mixer equipped with an atomizer spray system (identified as “MSRL”), while other samples were prepared by intermittently spraying the salt with the liquid saponin during dry blending.

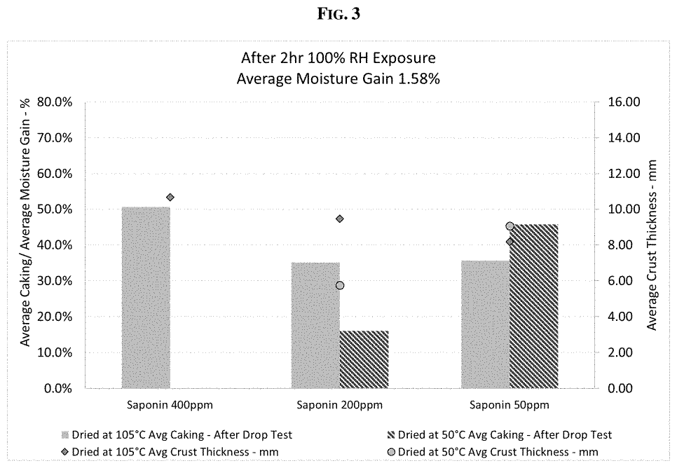

As shown in FIG. 3, all samples treated with saponin demonstrated reduced average caking and crust thickness, relative to the untreated Control Purex sample. The samples dried at 50° C. (gray) generally demonstrated greater reductions in average caking and crust thickness, as compared to the samples dried at 105° C. (orange bars). The saponin-treated samples all demonstrated soft caking, whereas the Control Purex demonstrated hard caking.

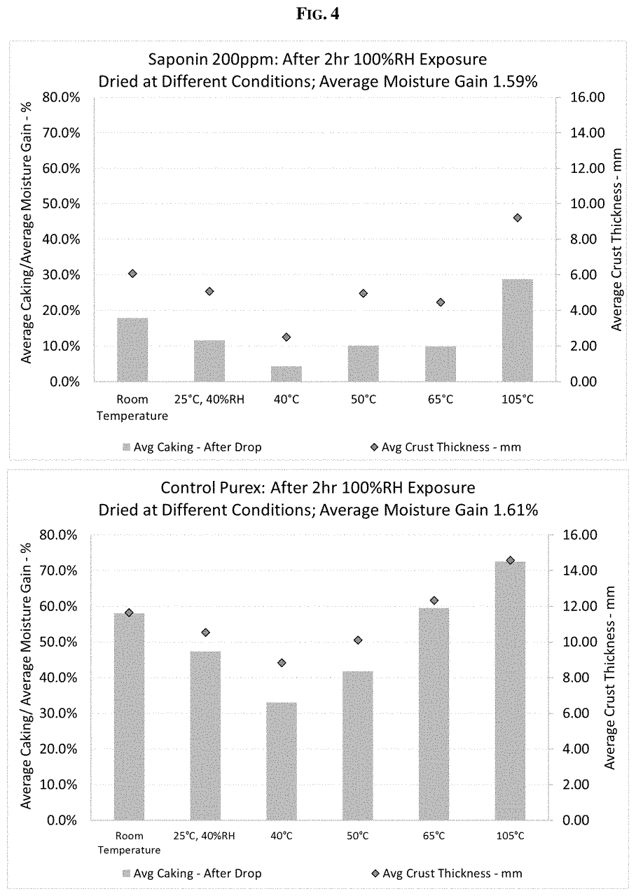

As shown in FIG. 4, all of the samples treated with 200 ppm saponin (top panel) demonstrated reductions in average caking and crust thickness, as compared to the untreated Control Purex samples dried under identical conditions (bottom panel). The saponin is effective in reducing average caking and crust thickness across all drying conditions tested, with the greatest reductions observed in samples dried at 40° C.

### Example 4—the Addition of an Anti-Foaming Agent Allows for Reductions in Saponin Concentration

Samples treated with liquid quillaja saponin (50 ppm or 200 ppm) were prepared as described above in the preceding Examples. Additional samples treated with saponin and anti-foaming agent (100 ppm canola oil or 400 ppm HPMC) were also prepared using similar methods. A sample treated with 0.1% coconut oil alone was also prepared according to the methods described above. The prepared samples were exposed to high humidity and dried at 50° C. for three hours. Each sample was then assessed for average caking and crust thickness, using the methods described above in Example 1.

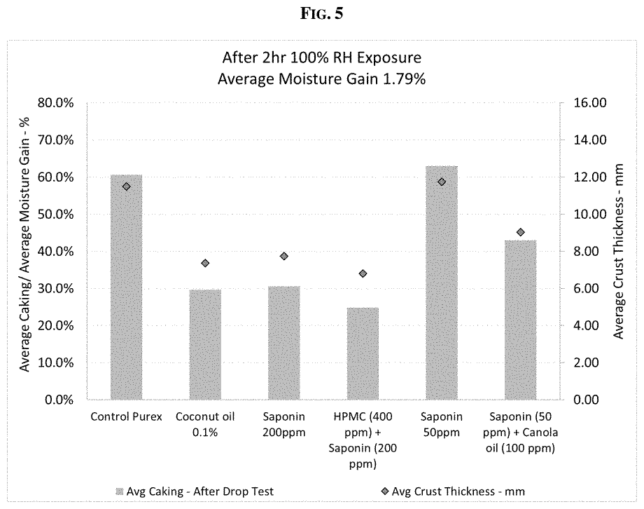

As shown in FIG. 5, treatment with 100 ppm canola oil and 50 ppm quillaja saponin, or 400 ppm HPMC and 200 ppm quillaja saponin, demonstrated improved reductions in average caking and crust thickness, as compared to the untreated Control Purex, and the sample treated with 50 ppm or 200 ppm quillaja saponin alone. Consistent with the above Examples, treatment with 200 ppm results in significant reductions in average caking and crust thickness, as compared to the untreated Control Purex. Treatment with 0.1% coconut oil alone also reduced average caking and crust thickness.

The present disclosure enables one of skill in the relevant art to make and use the inventions provided herein in accordance with multiple and varied embodiments. Various alterations, modifications, and improvements of the present disclosure that readily occur to those skilled in the art, including certain alterations, modifications, substitutions, and improvements are also part of this disclosure. Accordingly, the foregoing description are by way of example to illustrate the discoveries provided herein. Furthermore, the foregoing Description and Examples are exemplary of the present invention and not limiting thereof. The scope of the invention is therefore set out in the appended claims.

All patents and publications cited herein are fully incorporated by reference herein in their entirety.

1. A method of reducing caking and improving flowability of a powdered material, the method comprising:
adding an anti-caking agent to the powdered material to prepare a treated powdered material,
wherein:
the anti-caking agent comprises an agent selected from a saponin, potassium cocoate, and combinations thereof; and
the anti-caking agent is added to the powdered material at a concentration sufficient to reduce average caking of the powdered material to less than about 40 percent.

2. The method of claim 1, wherein the anti-caking agent comprises potassium cocoate.

3. The method of claim 1, wherein the anti-caking agent comprises a saponin.

4. The method of claim 3, wherein the saponin comprises a quillaja saponin.

5. The method of claim 4, wherein the quillaja saponin comprises an extract prepared from Quillaja saponaria Molina.

6. The method of claim 4, wherein the quillaja saponin comprises a compound selected from: 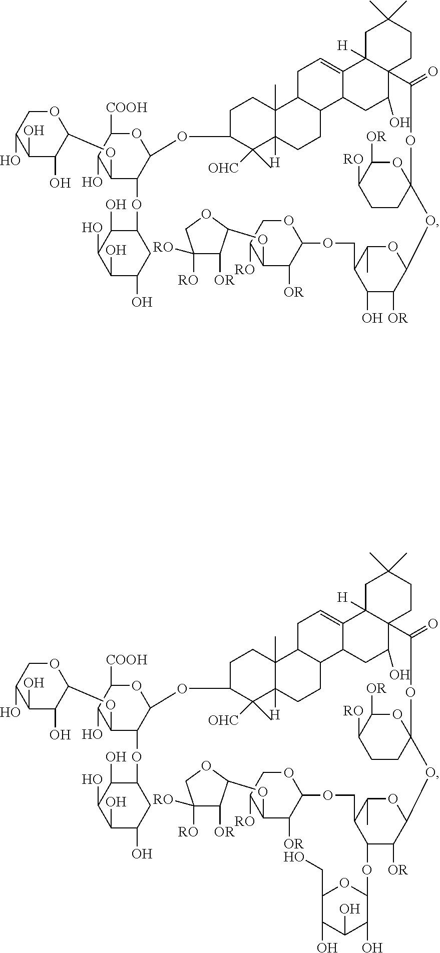
and combinations thereof, or a hydrate, solvate, tautomer, stereoisomer, or salt thereof, wherein each R is independently selected from —H, —CH₃, and —COOH.

7. The method of claim 1, wherein the anti-caking agent is added to the powdered material at a concentration sufficient to reduce an average crust thickness of caking within the powdered material by about 5% to about 80%, as compared to a sample of untreated powder material.

8. The method of claim 1, wherein the concentration of the anti-caking agent is about 10 ppm to about 4000 ppm.

9. The method of any claim 1, wherein the concentration of the anti-caking agent is about 40 ppm.

10. The method of claim 1, wherein adding an anti-caking agent to the powdered material comprises blending a dry formulation of the quillaja saponin with the powdered material.

11. The method of claim 1, wherein adding an anti-caking agent to the powdered material comprises applying a liquid formulation of the quillaja saponin to the powdered material.

12. The method of claim 1, wherein the method further comprises adding an anti-foaming agent to the powdered material.

13. The method of claim 12, wherein the anti-foaming agent is selected from an emulsifier, a surfactant, a hydrophobic oil, and a hydrophobic solid.

14. The method of claim 12, wherein the anti-foaming agent is selected from an oil, a wax, a polysorbate, an optionally modified polysaccharide, a fatty acid, sodium laurylglucosides hydroxypropylsulfonate, and a phosphate salt.

15. The method of claim 12, wherein the anti-foaming agent is selected from olive oil, coconut oil, potassium cocoate, canola oil, mineral oil, carnauba wax, hydroxypropyl methyl cellulose, polysorbate 80, calcium stearate, and sodium laurylglucoside hydroxypropylsulfonate.

16. The method of claim 15, wherein the anti-foaming agent comprises olive oil, and the olive oil is added to the powdered material at a concentration of about 50 ppm to about 20,000 ppm.

17. The method of claim 15, wherein the anti-foaming agent comprises potassium cocoate, and the potassium cocoate is added to the powdered material at a concentration of about 50 ppm to about 1000 ppm.

18. The method of claim 15, wherein the anti-foaming agent is carnauba wax, and the carnauba wax is added to the powdered material at a concentration of about 50 ppm to about 1000 ppm.

19. The method of claim 15, wherein the anti-foaming agent is hydroxypropyl methyl cellulose, and the hydroxypropyl methyl cellulose is added to the powdered material at a concentration of about 50 ppm to about 1000 ppm.

20. The method of claim 12, wherein the steps of adding an anti-caking agent and adding an anti-foaming agent comprise adding a single formulation comprising the anti-caking agent and the anti-foaming agent to the powdered material.

21. The method of claim 12, wherein the step of adding an anti-foaming agent comprises mixing the anti-foaming agent with the treated powdered material.

22. The method of claim 1, wherein the powdered material is a granulated powdered material.

23. The method of claim 1, wherein the powdered material is a foodstuff.

24. The method of claim 1, wherein the powdered material comprises sodium chloride.

25-46. (canceled)

47. A food-additive formulation comprising:
an anti-caking agent; and
a granulated foodstuff,
wherein:
the anti-caking agent comprises an agent selected from a saponin, potassium cocoate, and combinations thereof; and
a concentration of the anti-caking agent is about 10 ppm to about 4000 ppm and wherein the anti-caking agent is for reducing the caking of the granulated foodstuff and for improving the flowability of the granulated foodstuff.

48. The food additive formulation of claim 47, wherein the anti-caking agent comprises potassium cocoate.

49. The food additive formulation of claim 47, wherein the anti-caking agent comprises a saponin.

50. The food additive formulation of claim 49, wherein the saponin comprises a quillaja saponin.

51. The food additive formulation of claim 50, wherein the quillaja saponin comprises an extract prepared from Quillaja saponaria Molina.

52. The food additive formulation of claim 50, wherein the quillaja saponin comprises a compound selected from: 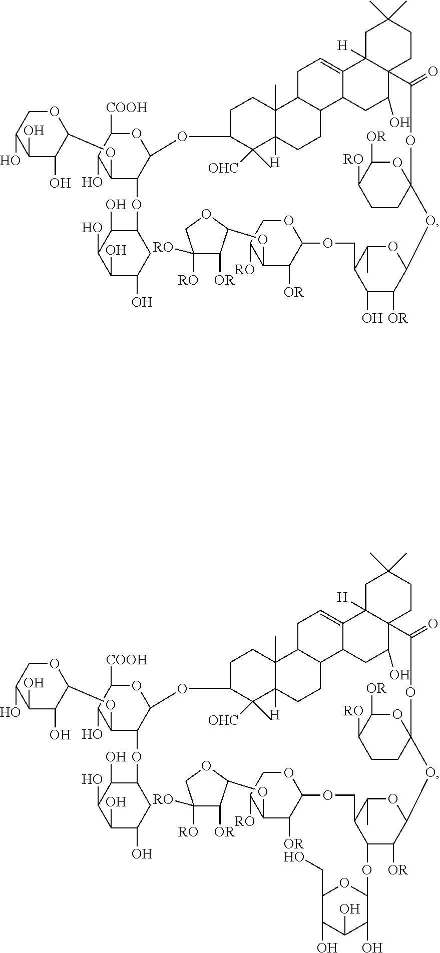
and combinations thereof, or a hydrate, solvate, tautomer, stereoisomer, or salt thereof, wherein each R is independently selected from —H, —CH₃, and —COOH.

53. The food additive formulation of claim 47, wherein the concentration of the anti-caking agent is about 40 ppm.

54. The food additive formulation of claim 47, wherein the anti-caking agent is provided as a dry powder formulation.

55. The food additive formulation of claim 47, wherein the anti-caking agent is provided as a liquid formulation.

56. The food additive formulation of claim 47, wherein the formulation further comprises an anti-foaming agent selected from an emulsifier, a surfactant, a hydrophobic oil, and a hydrophobic solid.

57. The food additive formulation of claim 47, wherein the formulation further comprises an anti-foaming agent selected from an oil, a wax, a polysorbate, an optionally modified polysaccharide, a fatty acid, sodium laurylglucoside hydroxypropylsulfonate, and a phosphate salt.

58. The food additive formulation of claim 47, wherein the formulation further comprises an anti-foaming agent selected from olive oil, coconut oil, potassium cocoate, canola oil, mineral oil, carnauba wax, hydroxypropyl methyl cellulose, polysorbate 80, calcium stearate, and sodium laurylglucoside hydroxypropylsulfonate.

59. The food additive formulation of claim 58, wherein the anti-foaming agent is olive oil, and the olive oil is present at a concentration of about 25 ppm to about 20,000 ppm.

60. The food additive formulation of claim 58, wherein the anti-foaming agent is potassium cocoate, and the potassium cocoate is present at a concentration of about 50 ppm to about 1000 ppm.

61. The food additive formulation of claim 58, wherein the anti-foaming agent is carnauba wax, and the carnauba wax is added to the foodstuff at a concentration of about 50 ppm to about 1000 ppm.

62. The food additive formulation of claim 58, wherein the anti-foaming agent is hydroxypropyl methyl cellulose, and the hydroxypropyl methyl cellulose is added to the foodstuff at a concentration of about 50 ppm to about 1000 ppm.

63. The food additive formulation of claim 47, wherein the granulated foodstuff comprises sodium chloride.

64-78. (canceled)
